(19) United States
(12) Patent Application Publication
(10) Pub. No.: US 2009/0064245 A1
(43) Pub. Date: Mar. 5, 2009

(54) Enhanced On-Line Collaboration System for Broadcast Presentations

(75) Inventors: Michael Dennis Facemire, Pittsboro, NC (US); Douglas John Geiger, Apex, NC (US); Michael C. Wanderski, Durham, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 11/845,801

(22) Filed: Aug. 28, 2007

(51) Int. Cl. H04N 7/173

(52) U.S. Cl. 725/105

(57) ABSTRACT

An enhanced on-line collaboration system is provided for subset of users viewing the same broadcast presentation at the same time. Each session is initiated by a single user sending a session request to a collaboration server. The request identifies members of a proposed subset and the broadcast presentation that is to be the subject of the collaboration. The request may also include an initial user collaboration input. The collaboration server establishes a final subset of available users and forwards any user collaboration input to broadcast redistributors associated with members of the final subset. Subsequent collaboration inputs from members of the final subset are forwarded to broadcast redistributors and appear as graphic or text overlays on the broadcast display seen by members of the final subset.

### BACKGROUND OF THE INVENTION

The present invention relates to computer network technology and more particularly to an enhanced on-line collaboration system for users receiving broadcast presentations.

The rapid growth in availability of reasonably-priced but nevertheless powerful personal computer systems coupled with explosive growth in the availability of data communications using high speed networks, such as the Internet, has created unprecedented opportunities for people to collaborate on-line with large numbers of other people on a local, national or even global scale.

Increases in the processing power available in many personal computer systems and increases in the end-to-end data transfer rates attainable through available networks have made it possible for users to collaborate with each other with without discernable delays between transmission and receipt of messages; i.e., on a real time or near-real time basis.

The present invention uses the processing power of available personal computers or other user workstations and the high attainable data transfer rates of available networks, such as the Internet, to provide a system that permits two or more users receiving a broadcast presentation to collaborate on-line on virtually a real-time basis about the broadcast presentation content.

### BRIEF SUMMARY OF THE INVENTION

The invention may be embodied as a method for enhancing on-line collaboration among a set of users receiving a broadcast presentation. A subset of users receiving the broadcast is established. An input from one of the users is received and added to the broadcast presentation signal to be provided to other users in the established subset.

The invention may also be embodied as a computer program product for enhancing on-line collaboration among a set of users receiving a broadcast presentation. The computer program includes a computer usable medium embodying computer program code. The embodied program code is configured to establish a subset of users receiving the broadcast presentation, to receive an input from one of the users in the established subset and to add the input to the broadcast presentation signal to be received by other users in the established subset.

Finally, the invention may be embodied as a collaboration server for enhancing on-line collaboration among a set of users receiving a broadcast presentation. The collaboration includes a user database including network addresses for the users. An input system receives an input from one of the users in the subset. The input identifies a particular broadcast and includes a request to form a subset of users receiving the identified broadcast as well as a user input relevant to the broadcast presentation. The server includes session control logic for establishing the subset and an output system for sending a request to a broadcast presentation provider, the request being to combine the received input with the broadcast presentation signal provided to one or more members of the subset.

### BRIEF DESCRIPTION OF THE SEVERAL VIEWS OF THE DRAWINGS

FIG. 1 is a pictorial illustration of a broadcast presentation environment, including redistributors and end users who receive the broadcast presentation.

FIG. 2 is a block diagram of an on-line collaboration system embodying the present invention.

FIG. 3 is a flow chart of operations that are performed in the illustrated on-line collaboration system.

FIG. 4 is a functional block diagram of a collaboration server for the on-line collaboration system.

FIG. 5 is a block diagram of a hardware infrastructure that can be used for the collaboration server, broadcast redistributors systems and end user systems.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

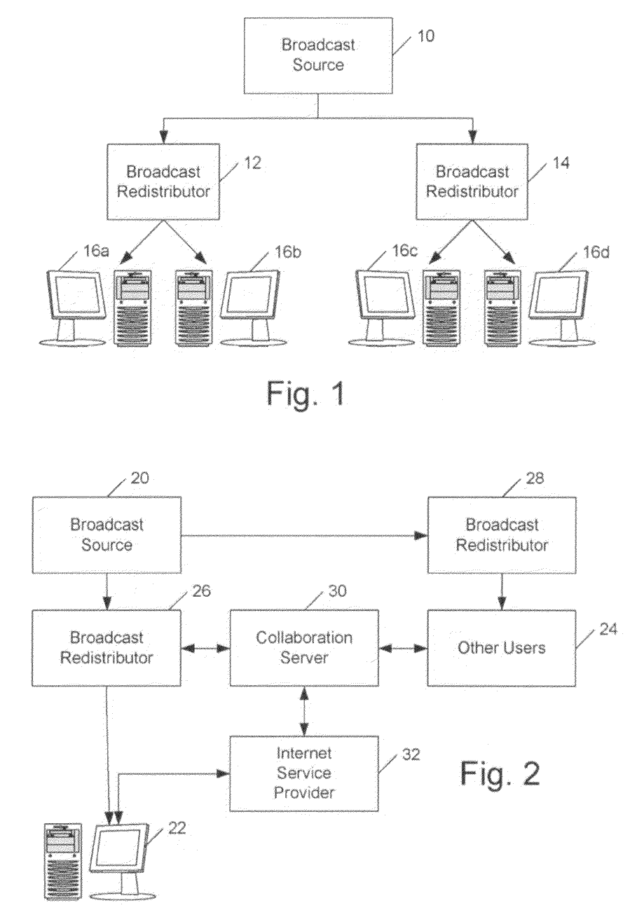

FIG. 1 is a high level representation of a broadcast system of the type that is used to distribute video (television) signals from a broadcast source 10 to users equipped with appropriate receiving apparatuses. While some broadcasts may be made directly from a source 10 to the receiving apparatuses, it is far more common for the broadcast signals to be redistributed through one or more tiers of broadcast redistributors, such as redistributors 12 and 14. One example of a broadcast redistributor is a local network television affiliate that acquires broadcast signals from a national network source and redistributes those signals to local users over the air, through satellite systems, or through suitable transmission media such as coaxial cables, fiber optic cables or DSL telephone cables. Another example of a broadcast redistributor is a cable company that acquires the broadcast signals from either a national source or from a local redistributors and then redistributes the acquired signal to local subscribers either through coaxial or fiber optic cables.

While a single broadcast redistributor is illustrated, it should be understood that there may be multiple tiers of redistributors between the original broadcast source and the ultimate end user that views the broadcast presentation. For example, a national television network may originate a broadcast presentation and provide the presentation both to local television affiliates and satellite system owners. The local television affiliates may distribute the signals directly to end user viewers while also providing the broadcast signals to local cable service providers for redistribution to end user viewers through coaxial or fiber optic cable systems.

Initially, broadcast receiving apparatuses were limited to conventional radio or television receivers. More recently, personal computer systems, such as systems 16A, 16B, 16C and 16D, have come to be equipped with television tuners that enable them to receive broadcast signals and to view the presentation content on the personal computer system monitor, either full screen or in a window. The fact that a user can sit and watch a broadcast presentation on the same system that lets the user communicate with remote systems and other users through networks such as the Internet makes it possible for the users to collaborate with each other while all are viewing the same broadcast presentation.

FIG. 2 is a system level block diagram of a system for enabling viewers of a broadcast presentation to collaborate in real time or near real-time with other viewers of the same broadcast presentation. A broadcast source 20 provides a broadcast signal that ultimately reaches an end user of a personal computer system 22 through a broadcast redistributor 26 and other end users, identified collectively as end users 24, through other broadcast redistributors 28. To simplify the description of the invention, the user of personal computer system 22 may be referred to as the local user while all other may be referred to collectively as remote users. It should not be implied from these terms that local and remote users are necessarily located long distances from each other. A particular “remote” user may be in close physical proximity to the local user and may even be served by the same broadcast redistributor.

To engage in on-line collaboration with other users, the local user communicates with a collaboration server 30 through the local user's Internet service provider 32. The primary functions of the collaboration server 32 are to establish subsets of users who want to engage in on-line collaboration about a particular broadcast presentation, receive collaboration inputs from those users and pass those inputs on to the broadcast redistributors serving the users. The broadcast redistributors combine the collaboration inputs with the video signals being distributed to users in the established subset. Collaboration inputs is a term that should be construed broadly enough to cover both text inputs (chat messages) and graphical annotations (arrows, circles, etc.) that can be generated by a user having a touch sensitive monitor or tablet. The collaboration inputs are presented to each user as overlays on the broadcast presentation.

The overlays can take the form of static chat windows or scrolling text windows superimposed on the video display. Additionally, a user with access to a touch-sensitive screen or a touch sensitive-table may “draw” on the video display to make his point to other members of the session subset. As one example, one golfer in a subset of golfers viewing a video presentation of the same televised professional golf tournament way want to draw an “x” on the video display to show just how much further he hit his ball on a particular hole than the professional golfer currently playing the same hole. As another example, viewers of mystery or forensic crime shows may want to mark certain evidence on the screen if they think other members of the collaborating subset have missed.

Obviously, annotations of the type described above are significant only as long as the scene to which they were originally applied remains on the screen. Therefore, it is contemplated that the broadcast redistributors will terminate graphical annotations either by associating them with particular scenes in a presentation and terminating the annotations when the scene ends or by maintaining the annotations only for a fixed, relatively brief period of time, on the order of one to three seconds.

In one embodiment, collaboration inputs provided by a local user may make a round trip through the user's internet service provider, collaboration server and broadcast redistributors before appearing on the local user's monitor screen. In another embodiment, program code running in the local user's system may overlay the collaboration inputs directly on the local user's monitor so those inputs do not need to make the round trip described. An advantage of the second embodiment is that there is no possibility of a delay before the local user sees the inputs on the user's own monitor.

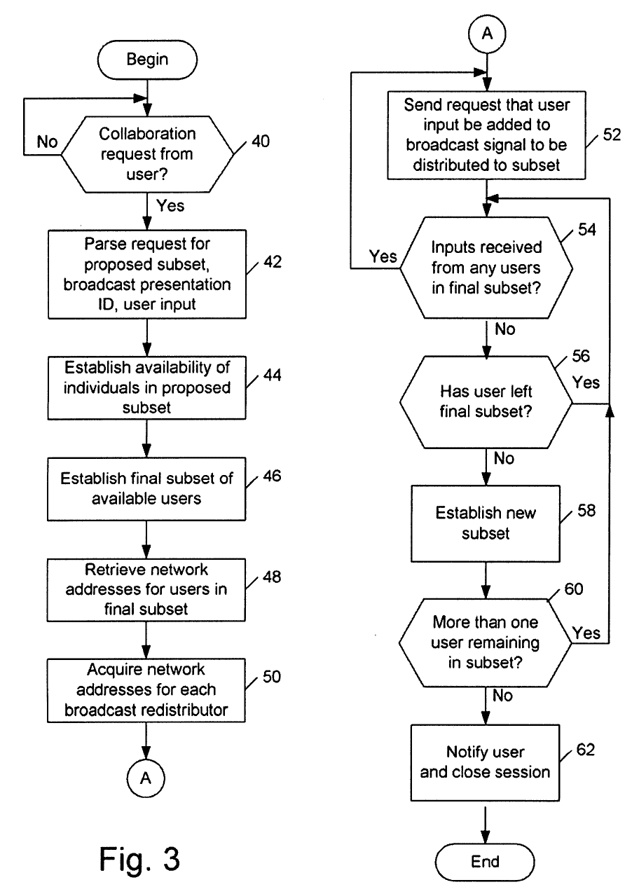

FIG. 3 is a flowchart of operations that are performed in the collaboration server 30 to support enhanced on-line collaboration among viewers of the same broadcast presentation. The process begins at step 40 with receipt of a collaboration request from a local user. The received collaboration request is parsed by the collaboration server to identify the requesting user, the subset of remote users with which the local user wishes to collaborate, and the identity of the broadcast presentation to which the collaboration is relevant. The collaboration request may also include the initial user input to be combined with the broadcast signal to be distributed to members of the subset.

The subset of users may be identified using the same sort of techniques that are commonly used today in e-mail and instant messaging systems. It is assumed that users of the collaboration system will have already completed a registration process with the system. As part of this registration process, users may establish distribution or buddy lists of other users with whom they wish to collaborate. It can be expected that users will establish multiple buddy lists, depending on the collaboration topic since not all users will have the same level of interest in all topics. For example, a buddy list for a group of users who are fans of the same professional football team may be substantially or totally different from a buddy list for a group of users who are golfers or fans of a particular college basketball team. Even where a user maintains multiple buddy lists at the collaboration server, it can be expected that the user may from time to time as being names of individual remote users to the subset with whom the local user proposes to collaborate. Of course, a user may elect to establish an ad hoc buddy list for a particular collaboration session by entering the names of the individual remote uses with whom he wishes to collaborate.

When the collaboration request is processed, the collaboration system 32 establishes the availability of members of the proposed subset in an operation 44. Known mechanisms may be used to establish availability. The collaboration server may maintain presence information for users in the same way that instant messaging servers maintain presence information for users that are logged onto the server. If the collaboration server does not maintain presence information, the server may establish availability of remote users by sending invitations to participate to those users and adding to the subset only those users who have positively responded to the invitation.

Once the collaboration server has established the availability of members of the proposed subset, a final subset of available users is established in step 46. The network addresses of the members of the final subset are shown as being retrieved in a step 48. Depending on how user availability is established, those network addresses may already be available to the collaboration server, making a separate address retrieval step unnecessary.

Once the final subset is established, the collaboration server must acquire, in step 50, the network address for each broadcast redistributor that serves each member of the final subset. There are a number of ways the broadcast redistributor addresses can be acquired. If the member has registered with the collaboration server, this information could be acquired as part of the registration process. It could also be acquired as part of the process of adding a user to someone else's buddy list or as part of a process for inviting a user to participate in a collaboration session.

Once the broadcast redistributor addresses have been acquired for all members of a final subset, the collaboration server sends a request (step 52) to each broadcast redistributor supporting a member of the final subset to combine the user input received as part of the initial session request with the broadcast signal stream being sent to that particular member. As noted earlier, it may not be necessary to send this request to the broadcast redistributor that serves the originating user since the originating user's own system may perform the combination at the local system.

The collaboration server then enters a wait loop where the server looks for collaboration inputs (in step 54) from any of the users in the final subset and forwards the inputs to the appropriate broadcast redistributors for redistribution to members of the final subset. Received collaboration inputs are sent to broadcast redistributors serving the members of subset as part of the wait loop operation.

While continuing to watch for user collaboration inputs, the collaboration server 32 also looks (in step 56) for any indication that one of the users in the final subset has taken steps to leave the subset. As each user leaves the subset, a new smaller subset is established in step 58 and a check is made (step 60) as to whether there at least two collaborators remaining in the subset. When the check 60 shows that the subset has dwindled to a single user, the remaining user is notified in step 62 that there is no one left with whom to collaborate and the collaboration session is terminated.

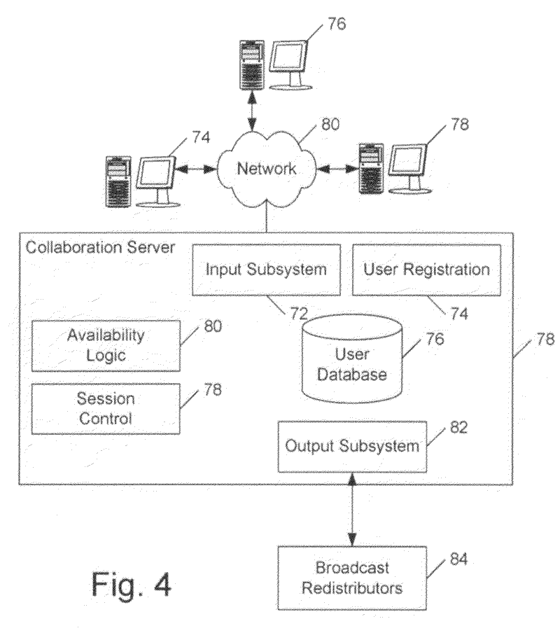

The collaboration server may be implemented as a programmable general purpose computer having an infrastructure of a type which will be described in more detail below. Alternatively, the collaboration server may be implemented as a dedicated device including microcode or some program code to implement the necessary collaboration server functions in dedicated hardware components. FIG. 4 is a functional block diagram of such a dedicated device. The collaboration server 70 includes an input subsystem 72 that provides an interface to a community of end-users controlling end-user systems, such as systems of 74, 76 and 78, that typically connect to the collaboration server 72 an intervening network 80, such as the Internet. The input subsystem 72 would receive the initial session request from the originating user and any further inputs within the session from either the originating user or any other member of the final subset that is established.

The collaboration server 70 also may include a user registration module 74 that is used to obtain and store information about subscribers to the collaboration server. As noted earlier, the user registration information can include the user network address as well as a network address for each broadcast redistributor serving the user. If the collaboration server is a paid service, the registration information for each user may also include mailing addresses and billing information (credit card types, credit card numbers, expiration dates, etc.) for each of the users. User information is stored in the user database 76 either integral to the collaboration server or, if external to the collaboration server, accessible by the server.

The collaboration server also includes session control logic 78 for opening, closing, and restructuring user sessions. The session control logic 78 may be supported by availability logic 80 that is used to determine the availability of members for participation in a particular collaboration session.

Finally, the collaboration server 70 includes an output subsystem 82 that provides the interface between the remainder of the system and each of the broadcast redistributors 84 supporting members of a final subset.

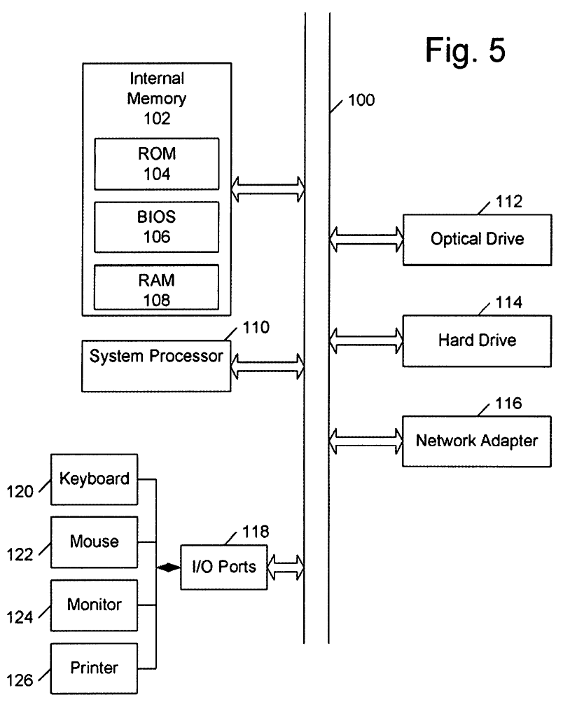

As noted earlier, the collaboration server may be implemented as a special purpose hardware system of the type described above or as a programmable general purpose computer system having a hardware infrastructure of the type disclosed in FIG. 5.

A suitable general purpose computer system includes an internal system bus 100, a system processor 110, internal memory components 102 and one or more “external” memory components, such as an optical drive 112 and a magnetic hard drive 114. The internal memory 102 includes specific types of memory such as read only memory (ROM) 104, basic input/out system (BIOS) memory 106 and random access memory (RAM) 108. The BIOS 106 stores configuration information for the computer system and basic routines used to control the transfer of information among the components of the computer system.

Drives, such as optical drive 112 and hard drive 114, provide non-volatile storage for applications and processes that execute in the computer system and for data used in and/or generated by those applications and processes. Depending on the technology employed, the drives may include removable media. The special purpose programming needed by a computer system to implement the described invention would typically be stored in one of these drives and transferred as needed into RAM 108.

The computer system also includes a significant number of input/output (I/O) ports 118 that provide interfaces between a variety of input/output devices and the remainder of the computer system. Common examples of input/output devices include keyboard 120, mouse 122, monitor 124 and printer 126.

It should not be inferred that only the devices shown in FIG. 5 can be part of the computer system. There are simply too many different types of input/output devices to include in a drawing. Moreover, it should not be implied that the input/output ports 118 are limited to a particular technology. There are many different types of input/output ports that are used as device interfaces. Current examples of port technologies that are successfully used include serial ports, parallel ports, SCSI, USB ports, FireWire ports and infrared ports. Other port technologies undoubtedly already exist or will be developed.

Finally, the computer system will include one or more network adapters 116 that are needed to establish communications between the general purpose computer system and other computers. Many different types of network adapters exist today and there is no intent to limit the description to a particular type.

The hardware infrastructure shown in FIG. 5 is quite generic and could be used for the collaboration server, the broadcast redistributors systems and the end user systems described above with appropriate changes. For example, a television tuner would probably have to be added to the system in order to provide the necessary functions of the end user systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the foregoing description has focused on the use of the present invention in providing enhanced on-line collaboration for viewers of video forecasts, the ability to engage in enhanced on-line collaboration may also prove attractive to listeners of audio broadcasts. Moreover, while the description has been in terms of broadcast presentations, the use of that term should not imply that only live broadcasts are contemplated. The invention can be used with live and recorded broadcasts from national sources and with recorded re-broadcasts that may originate regionally or even locally with broadcast redistributors. The only requirement is that the same subset of viewers be viewing the same content at substantially the same time, regardless of where that content originates.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for enhancing on-line collaboration among a set of individuals receiving a broadcast presentation comprising:
establishing a subset of the individuals receiving the broadcast presentation;
receiving an input from one of the individuals in the established subset; and
adding the input to the broadcast presentation signal to be received by other individuals in the subset.

2. A method according to claim 1 wherein establishing a subset of the individuals receiving the broadcast presentation further comprises:
receiving a request from one of the individuals in the subset to establish the subset;
confirming the availability of one or more other the other individuals for participation in the subset; and
redefining the subset to include only the requesting individual and one or more individuals whose availability for participation has been confirmed.

3. A method according to claim 2 further including:
receiving one or more inputs from individuals in the subset other than the requesting individual; and
adding received inputs to the broadcast presentation signals being distributed to all individuals in the subset.

4. A method according to claim 3 wherein received inputs comprise visual artifacts that are to appear on a video display used by an individual in the subset.

5. A method according to claim 4 wherein the broadcast presentation is a video presentation and the visual artifacts include graphical annotations that are to be superimposed on the video presentation appearing on the video display.

6. A method according to claim 5 wherein the visual artifacts further include text messages that are to be superimposed on the video presentation appearing on the video display.

7. A computer program product for enhancing on-line collaboration among a set of individuals receiving a broadcast presentation, the computer program product comprising a computer usable medium having computer usable program code embodied therewith, the computer usable program code comes prizing;
computer usable program code configured to establish a subset of the individuals receiving the broadcast presentation;
computer usable program code configured to receive an input from one of the individuals in the established subset; and
computer usable program code configured to add the input to the broadcast presentation signal to be received by other individuals in the subset.

8. A computer program product according to claim 7 wherein the computer usable program code configured to establish a subset of the individuals receiving the broadcast presentation further comprises;
computer usable program code configured to receive a request from one of the individuals in the subset to establish the subset;
computer usable program code configured to confirm the availability of one or more other the other individuals for participation in the subset; and
computer usable program code configured to redefine the subset to include only the requesting individual and one or more individuals whose availability for participation has been confirmed.

9. A computer program product according to claim 8 further comprising:
computer usable program code configured to receive one or more inputs from individuals in the subset other than the requesting individual; and
computer usable program code configured to add received inputs to the broadcast presentation signals being distributed to all individuals in the subset.

10. A computer program product according to claim 9 wherein received inputs comprise visual artifacts that are to appear on a video display used by an individual in the subset.

11. A computer program product according to claim 10 wherein the broadcast presentation is a video presentation and the visual artifacts include graphical annotations that are to be superimposed on the video presentation appearing on the video display.

12. A computer program product according to claim 11 wherein the visual artifacts further include text messages that are to be superimposed on the video presentation appearing on the video display.

13. A collaboration server for enhancing on-line collaboration among a set of individuals receiving a broadcast presentation comprising:
a database including individual records, each record identifying an individual and a network address associated with the individual;
an input system for receiving an input signal originating with an individual, the input signal comprising
a request to form a subset of one or more other individuals included in the database,
information identifying a broadcast presentation, and
an input from the member; and
an output system for sending an output signal to a broadcast presentation provider, the output signal comprising
a request to the combine the member input with broadcast presentation signal being provided to one or more members of the subset.

14. A collaboration server according to claim 13 wherein the input system further comprises:
an availability subsystem for confirming the availability of one or more of the individuals identified in the received request for participation in on-line collaboration;
a redefinition subsystem for redefining the subset to include only the requesting individual and one or more individuals whose availability for participation has been confirmed.

15. A collaboration server according to claim 14 wherein the input system receives one or more inputs from individuals in the subset other than the requesting individual and sends signals to the output system to be transmitted as output signals by the output system.

16. A collaboration server according to claim 15 wherein received inputs comprise visual artifacts that are to appear on a video display used by an individual in the subset.

17. A collaboration server according to claim 16 wherein the broadcast presentation is a video presentation and the visual artifacts include graphical annotations to be superimposed on the video presentation appearing on the video display.

18. A collaboration server according to claim 17 wherein the visual artifacts further include text messages to be superimposed on the video presentation appearing on the video display.
